(19) United States
(12) Patent Application Publication
(10) Pub. No.: US 2014/0168227 A1
(43) Pub. Date: Jun. 19, 2014

(54) SYSTEM AND METHOD FOR VERSIONING BUFFER STATES AND GRAPHICS PROCESSING UNIT INCORPORATING THE SAME

(71) Applicant: NVIDIA CORPORATION, Santa Clara, CA (US)

(72) Inventor: Albert Meixner, Mountain View, CA (US)

(73) Assignee: NVIDIA CORPORATION, Santa Clara, CA (US)

(21) Appl. No.: 13/713,340

(22) Filed: Dec. 13, 2012

(51) Int. Cl. G06F 12/10; G09G 5/36

(52) U.S. Cl. CPC G06F 12/1045; G09G 5/363
USPC 345/502; 711/207

(57) ABSTRACT

A system and method for versioning states of a buffer. In one embodiment, the system includes: (1) a page table lookup and coalesce circuit operable to provide a page table directory request for a translatable virtual address of the buffer to a page table stored in a virtual address space and (2) a page directory processing circuit associated with the page table lookup and coalesce circuit and operable to provide a translated virtual address based on the virtual address and a page table load response received from the page table.

### TECHNICAL FIELD

This application is directed, in general, to pipelined parallel processors and, more specifically, to a system and method for versioning buffer states for a pipelined parallel processor and graphics processing unit (GPU) incorporating the system or the method.

### BACKGROUND

Many computer graphic images are created by mathematically modeling the interaction of light with a three-dimensional (3D) scene from a given viewpoint. This process, called “rendering,” generates a two-dimensional (2D) image of the scene from the given viewpoint, and is analogous to taking a photograph of a real-world scene.

As the demand for computer graphics, and in particular for real-time computer graphics, has increased, computer systems with graphics processing subsystems adapted to accelerate the rendering process have become widespread. In these computer systems, the rendering process is divided between a computer's general purpose central processing unit (CPU) and the graphics processing subsystem, architecturally centered about a GPU. Typically, the CPU performs high-level operations, such as determining the position, motion, and collision of objects in a given scene. From these high-level operations, the CPU generates a set of rendering commands and data defining the desired rendered image or images. For example, rendering commands and data can define scene geometry, lighting, shading, texturing, motion, and/or camera parameters for a scene. The graphics processing subsystem creates one or more rendered images from the set of rendering commands and data.

Many graphics processing subsystems are highly programmable through an application programming interface (API), enabling complicated lighting and shading algorithms, among other things, to be implemented. To exploit this programmability, applications can include one or more graphics processing subsystem programs, which are executed by the graphics processing subsystem in parallel with a main program executed by the CPU. Although not confined merely to implementing shading and lighting algorithms, these graphics processing subsystem programs are often referred to as “shading programs,” “programmable shaders,” or simply “shaders.”

Shaders employ constants that are stored in one or more buffer resources in memory. They can be organized into two types of buffers: constant buffers (cbuffers) and texture buffers (tbuffers). Constant buffers are optimized for constant-variable usage, which is characterized by lower latency access and more frequent update from the CPU.

Graphics application program, or programming, interfaces (APIs) define an abstraction of a processor that processes the input commands sequentially and in the order they were issued. In practice, modern graphics processing units (GPUs) execute many API calls concurrently for maximal performance. To maintain the abstraction of in-order processing, GPUs must be able to determine the API state as a function of time (which typically involves creating multiple versions of the API state), such that each API call can have access to the state that was current when it was issued. This is particularly challenging for constant buffers, which are larger than other those employed for other render states and are frequently updated.

### SUMMARY

One aspect provides a system for versioning states of a buffer. In one embodiment, the system includes: (1) a page table lookup and coalesce circuit operable to provide a page table directory request for a translatable virtual address of the buffer to a page table stored in a virtual address space and (2) a page directory processing circuit associated with the page table lookup and coalesce circuit and operable to provide a translated virtual address based on the virtual address and a page table load response received from the page table.

Another aspect provides a method of versioning states of a buffer. In one embodiment, the method includes: (1) storing a page table in a virtual address space, (2) providing a page table directory request for a translatable virtual address of the buffer to the page table and (3) providing a translated virtual address based on the virtual address and a page table load response received from the page table.

Yet another aspect provides a GPU. In one embodiment, the GPU includes: (1) a plurality of streaming multiprocessors, (2) a corresponding plurality of memories and (3) a system for versioning states of a constant buffer storable in the plurality of memories, the system including: (3a) a page table lookup and coalesce circuit operable to provide a page table directory request for a translatable virtual address of the constant buffer to a page table stored in a virtual address space and (3b) a page directory processing circuit associated with the page table lookup and coalesce circuit and operable to provide to one of the memories a translated virtual address based on the virtual address and a page table load response received from the page table.

### BRIEF DESCRIPTION

Reference is now made to the following descriptions taken in conjunction with the accompanying drawings, in which:

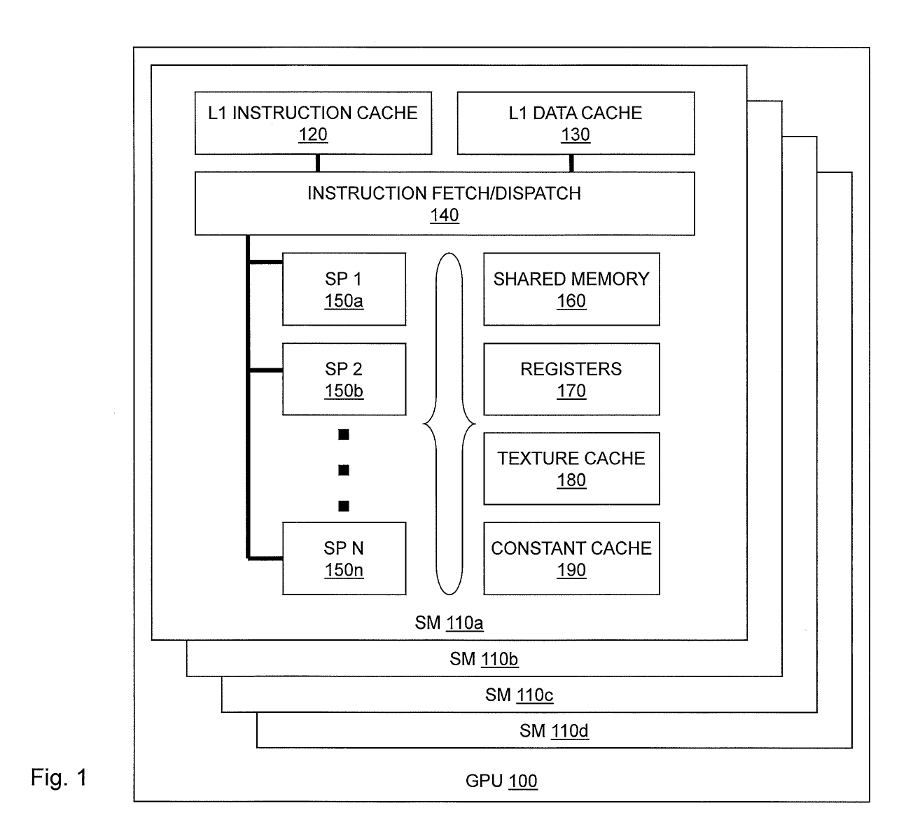

FIG. 1 is a block diagram of a GPU incorporating a system or method for versioning buffer states;

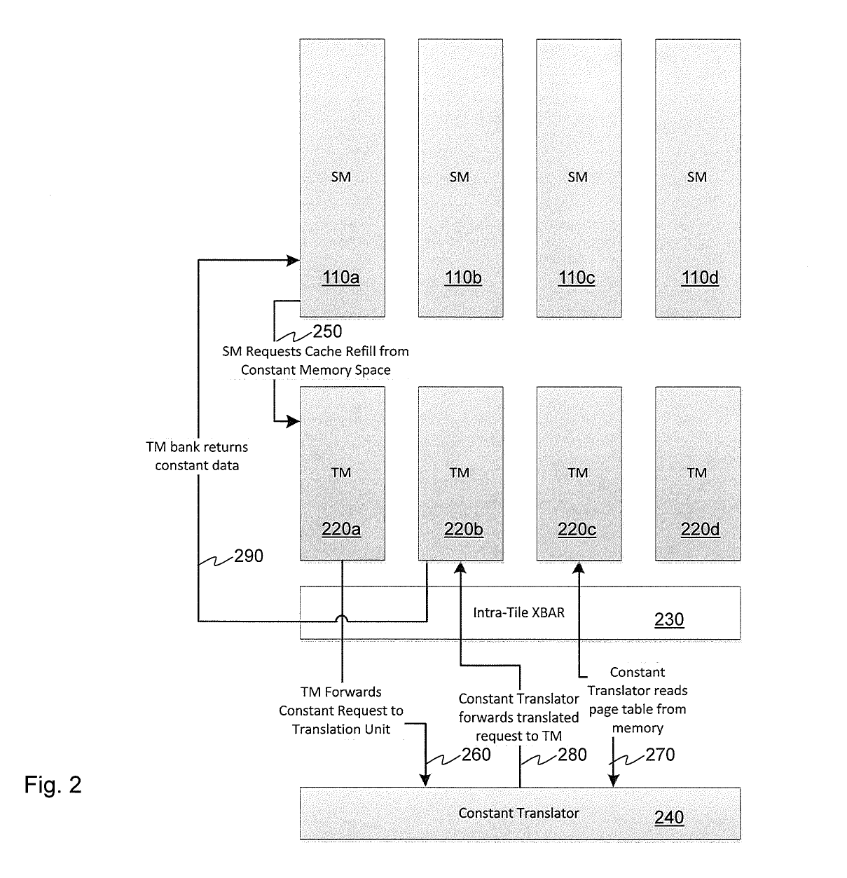

FIG. 2 is a high-level block diagram of one embodiment of a portion of the GPU of FIG. 1 together with one embodiment of a system for versioning buffer states;

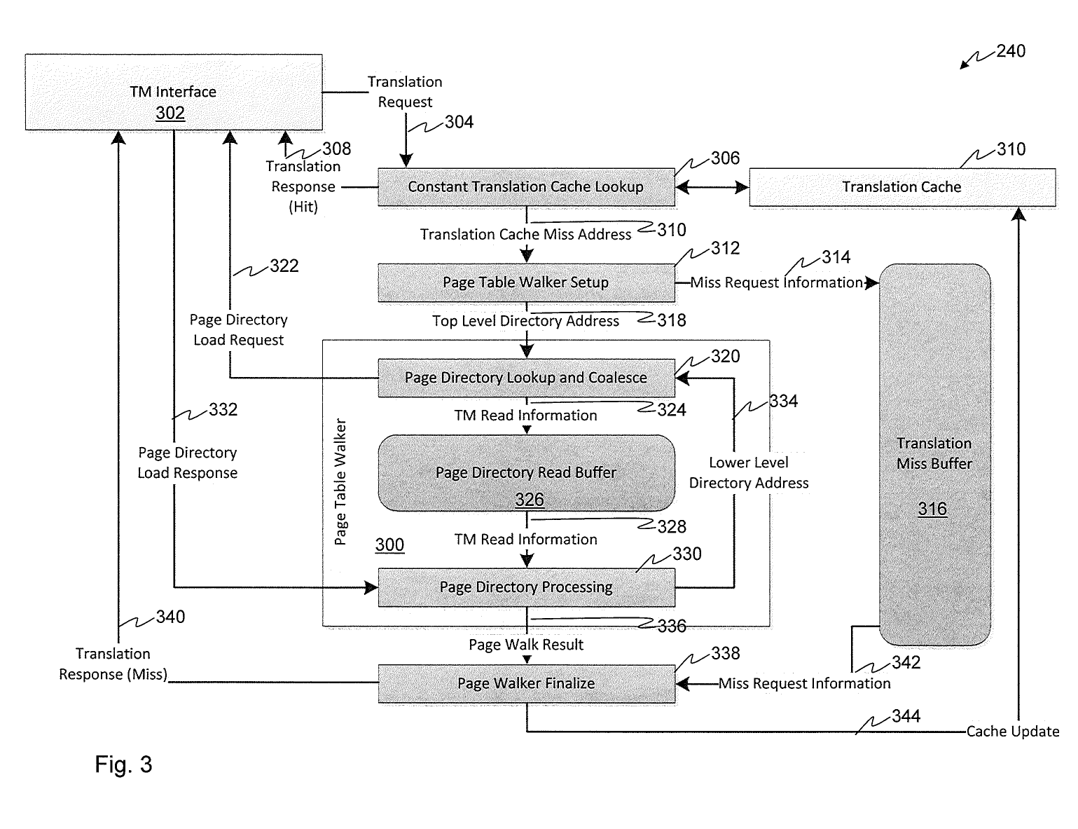

FIG. 3 is a lower-level block diagram illustrating one embodiment of VA-to-VA translation as may be carried out in a constant translator of FIG. 2;

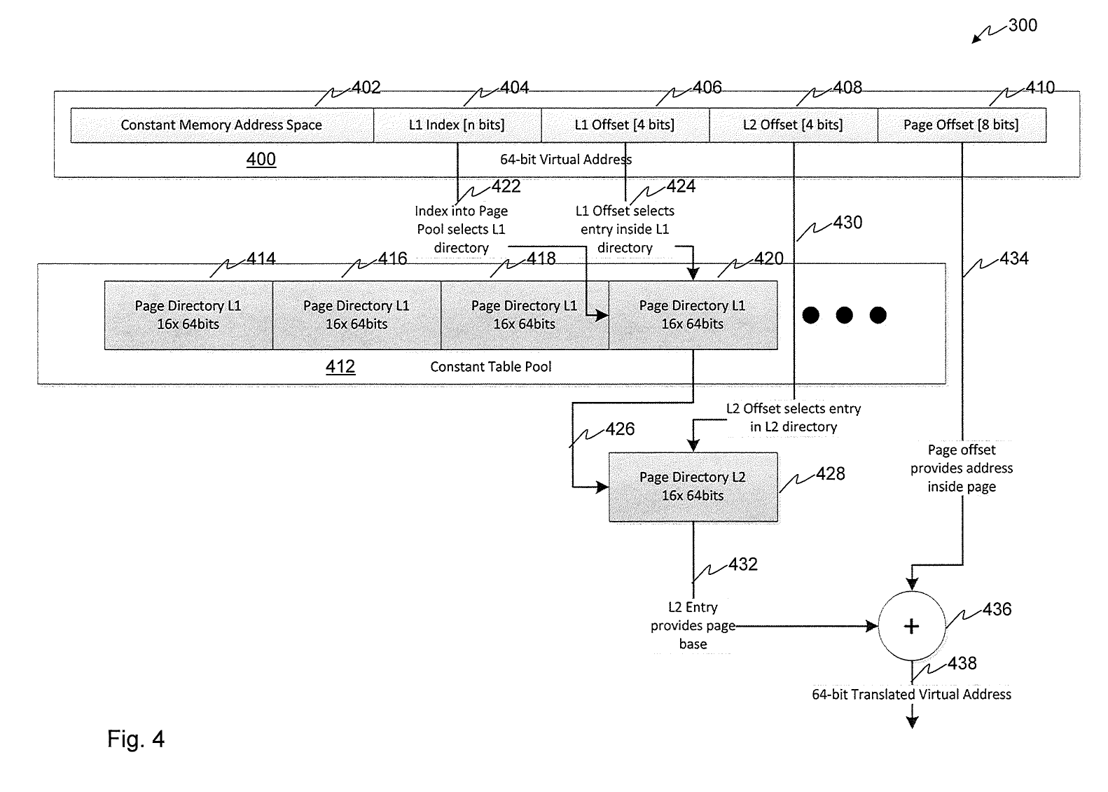

FIG. 4 is a diagram illustrating address translation in a page table walker of FIG. 3; and

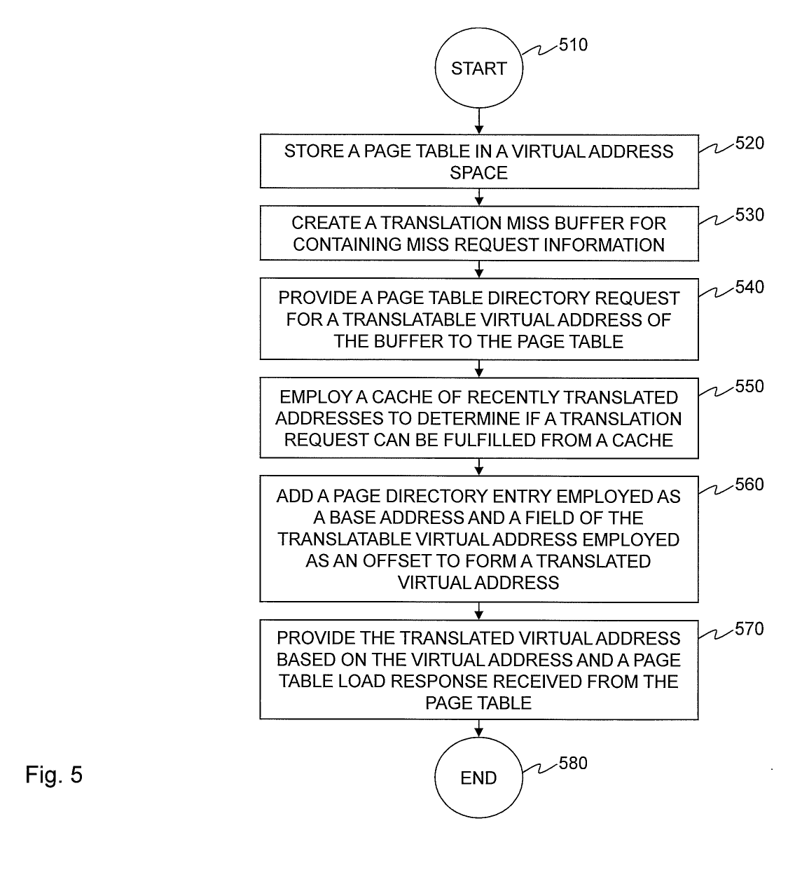

FIG. 5 is a flow diagram of one embodiment of a method of versioning buffer states.

### DETAILED DESCRIPTION

As stated above, determining the API state as a function of time is particularly challenging for constant buffers, which are larger than other those employed for other render states and are frequently updated. Absent an efficient mechanism for versioning constant buffer states, shading may become a bottleneck in graphics rendering.

Some modern GPUs solve versioning by storing only the most recent version in memory and keeping modified parts of older versions in a special pool. The pool uses associative lookups to find the correct data for an old version of a line of the constant buffer. It is realized herein that the associative lookup may be difficult to virtualize or context-switch. It is further realized herein that the associative lookup requires not only hardware support to create new versions but a special constant cache that contains data indicating the versioning.

A few options do exist for fully virtualizable, context-switchable, and software-controllable versioning. The first option involves create new buffer versions by copying the entire constant buffers on updates or use the virtual memory system to implement copy-on-write updates. Unfortunately, this option incurs a large overhead for small buffer updates, because even a single-word update would require 64 kilobytes (a typical size for a constant buffer) to be replicated in its entirety. The second option involves updating the page table for the buffer. However, making any change to the page table requires operating system (OS)-level privileges and still requires an entire page (4-64K) of the constant buffer to be replicated for each update.

Introduced herein are various embodiments of a system or method for versioning of states in parallel pipelines. The system and method embodiments described herein employ a virtual-address to virtual-address (VA-to-VA) translator to create constant buffers using copy-on-write. Unlike a virtual memory page translator, the VA-to-VA translator stores the page table in the virtual address space, and its output, i.e., the translated addresses, are also virtual addresses. Because all addresses involved are virtual, it is safe to allow all updates to occur in user mode without special OS-level privileges. In some embodiments, translations occur at the granularity of a single cache-line (e.g., 128 bytes) instead of a larger page to mitigate the effect of relatively small updates.

In embodiments to be illustrated and described below, a virtual base address identifies each version of the constant buffer. Hence, versioned constants can be cached in any virtually addressed cache. Versions are resolved during cache refill. To identify the address as versioned, the constant buffer is allocated in a special VA-range. Upon the refill, a memory management unit (MMU) determines, based on the address range, that an address should undergo VA-to-VA translation before being translated to a physical address. In certain embodiments, the VA-to-VA translation itself is performed by a two-level constant translator having a smaller translation cache backed by a larger cache connected to a page table walker. In certain embodiments to be illustrated and described, the larger cache and page table walker are shared across multiple first-level caches.

The number of versions that can exist concurrently is bounded only by the size of the VA-to-VA translation table and the size of the VA-range assigned to the translator. No inherent architectural limits exist with respect to either of these apart from the size of the virtual address space. Hence, a large number of versions can be supported if advantageous in a particular environment. Also, because the translation tables exist in the virtual address space, they are easily context-switchable as long as the translation caches are marked with an address space identifier.

Software may create new constant buffer versions by first allocating a new address range and then copying the mapping table of an older version. The software may then allocate storage space for updated lines, copy contents from the older version, update the lines, and remap them in the translation table.

Before describing embodiments of the unified system and method, a GPU architecture will be described. FIG. 1 is a block diagram of a GPU 100 incorporating a system or method for versioning buffer states. The GPU 100 includes multiple streaming multiprocessors (SMs) 110a, 110b, 110c, 110d. Only the SM 110a will be described, with the understanding that the other SMs 110b, 110c, 110d are of similar architecture. In the embodiment of FIG. 1, the SMs 110a, 110b, 110c, 110d have a single-instruction, multiple-data (SIMD) architecture. Other embodiments employ other architectures.

The SM 110a includes a level-1 instruction cache 120 and a level-1 data cache 130. An instruction fetch/dispatch unit 140 is configured to fetch instructions and dispatch them to various streaming processors (SPs) 150a, 150b, 150n for execution. Each SP 150a, 150b, 150n is configured to receive instructions dispatched to them from the L1 instruction cache 120, fetch germane operands from the L1 data cache 130, execute the instructions and write results back to memory. One embodiment of the SM 110a has four SPs 150a, 150b, 150n. Other embodiments of the GPU 100 have lesser or greater numbers of streaming cores 150a, 150b, 150n.

In the illustrated embodiment, the SM 110a also includes a shared memory 140, registers 150, a texture memory cache 160 and a constant memory cache 170. Other embodiments of the SM 110a omit one or more of the shared memory 140, the registers 150, the texture memory cache 160 and the constant memory cache 170, include further portions or units of memory or arrange the memory in a different way.

FIG. 2 is a high-level block diagram of one embodiment of a portion of the GPU of FIG. 1 together with one embodiment of a system for versioning buffer states. Memories, which may be tile memories (TMs) 220a, 220b, 220c, 220d contain constant buffers from which the respective constant memory caches 170 (not shown in FIG. 2) in the respective SMs 110a, 110b, 110c, 110d are refilled. An intra-TM crossbar (xbar) 230 allows data stored in the TMs 220a, 220b, 220c, 220c to be communicated with any of the SMs 110a, 110b, 110c, 110d. In FIG. 2, an embodiment of the system is contained in a constant translator 240. Though the constant translator 240 is illustrated as being a separate circuit, in one embodiment the constant translator 240 is integrated into one or more MMUs associated with the TMs 220a, 220b, 220c, 220c.

Various lines in FIG. 2 indicate the flow of information as constants are requested and provided. For example, an SM (e.g., the SM 110a) experiences a constant memory cache miss and therefore requests a refill of data from the TM 220a, as a line 250 represents. The MMU (not shown) associated with the TM 220a determines, based on the virtual address of the requested refill, that the address should undergo VA-to-VA translation before being translated to a physical address. For purposes of the present disclosure, a virtual address that lies in a range of addresses allocated to the constant buffer is a “translatable virtual address.” Accordingly, the MMU forwards the requested translatable virtual address to the constant translator 240, as a line 260 represents. The constant translator 240 responds by reading the appropriate page table from the appropriate TM, assumed in this example to be from the TM 220c, as a line 270 indicates. The constant translator 240 then translates the translatable virtual address to yield a translated virtual address and forwards it to the appropriate TM, assumed in this example to be from the TM 220b, as a line 280 indicates. Using the xbar 230, the TM 220b returns constant data to the SM 110a, as the line 290 indicates.

One embodiment of a mechanism by which the VA-to-VA translation may be performed in the constant translator 240 will now be described. FIG. 3 is a lower-level block diagram illustrating one embodiment of VA-to-VA translation as may be carried out in the constant translator of FIG. 2.

A TM interface 302 is configured to provide an interface to the xbar 230 of FIG. 2. A translation request (i.e., a translatable virtual address) is provided via the TM interface 302 to a constant translation cache lookup circuit 306 (which serves a translation lookaside circuit), as a line 304 indicates. The constant translation cache lookup circuit 306 employs a cache of recently translated addresses to determine if the translation request can be fulfilled from the cache 310. If the constant translation lookup circuit 306 indicates a cache hit, the response, which takes the form of a translated virtual address, is provided back via the TM interface 302. In an alternative embodiment constant translation lookaside buffers may be contained in the TMs 220a, 220b, 220c, 220c of FIG. 2, perhaps obviating the constant translation cache lookup circuit 306.

If the constant translation lookup circuit 306 indicates a cache miss, the constant translation lookup circuit 306 provides the translation cache miss address to a page table walker setup circuit 312, as a line 310 indicates. The page table walker setup circuit 312 provides miss request information to a translation miss buffer 316 and a top level directory address to a page directory lookup and coalesce circuit 320 of a page table walker 300, as lines 314, 318 indicate.

The page directory lookup and coalesce circuit 320 provides a page directory load request via the TM interface 302 and TM read information to a page directory read buffer 326 of the page table walker 300, as lines 322, 324 indicate. The TM read information continues on to a page directory processing circuit 330 of the page table walker 300, as a line 328 indicates.

The page directory processing circuit 330 receives a page directory load response from the TM interface 302 and provides a lower level director address to the page directory lookup and coalesce circuit 320, as lines 332, 334 indicate. The page directory processing circuit 330 also provides a page walk result to a page walker finalize circuit 338, as a line 336 indicates. The page walker finalize circuit 338 receives miss request information from the translation miss buffer 316 and provides a translation response indicating a cache miss to the TM interface 302 and updates the translation cache 310 as lines 342, 340, 344 indicate.

One embodiment of VA-to-VA address translation as may be carried out in the page table walker 300 will now be described more particularly in FIG. 4. Illustrated in FIG. 4 is a 64-bit VA 400 requiring translation. The illustrated embodiment of the page table walker 300 carries out a two-level translation employing level-1 (L1) and level-2 (L2) addressing. Therefore, in addition to a constant memory address space pointer 402 in the VA 400, the VA 400 includes an L1 index 404, an L1 offset 406, an L2 offset 408 and a page offset 410.

A constant table pool 412 contains various L1 page directories 414, 416, 418, 420. As is apparent in FIG. 4, VA-to-VA address translation may be carried out by employing the L1 index 404 to select, from the various L1 page directories 414, 416, 418, 420, the appropriate L1 directory (e.g., the L1 page directory 420), as a line 422 indicates. Then the L1 offset 406 may be employed to select an appropriate entry inside the selected L1 directory, as a line 424 indicates.

The entry thus selected may then be employed to select the appropriate L2 page directory (e.g., the L2 page directory 428, as a line 426 indicates. Then the L2 offset 408 may be employed to select the appropriate entry inside the selected L2 page directory 428.

The entry thus selected provides the page base of the translated VA. The page offset 410, which provides the page offset of the translated VA may then be provided to an adder, as lines 432, 434 indicate. When the page base and the page offset are added, the complete translated VA results.

Those skilled in the art will understand that, while FIG. 4 shows example data formats, data widths and numbers of entries, other embodiments encompass other data formats, data widths and numbers of entries.

FIG. 5 is a flow diagram of one embodiment of a method of versioning buffer states. The method begins in a start step 510. In a step 520, a page table is stored in a virtual address space. In a step 530, a translation miss buffer for containing miss request information is created. In a step 540, a page table directory request for a translatable virtual address of the buffer is provided to the page table. In a step 550, a cache of recently translated addresses is employed to determine if a translation request can be fulfilled from a cache. In a step 560, a page directory entry employed as a base address is added to a field of the translatable virtual address employed as an offset to form the translated virtual address. In a step 570, a translated virtual address based on the virtual address and a page table load response received from the page table is provided. The method ends in an end step 580.

Those skilled in the art to which this application relates will appreciate that other and further additions, deletions, substitutions and modifications may be made to the described embodiments.

What is claimed is:

1. A system for versioning states of a buffer, comprising:
a page table lookup and coalesce circuit operable to provide a page table directory request for a translatable virtual address of said buffer to a page table stored in a virtual address space; and
a page directory processing circuit associated with said page table lookup and coalesce circuit and operable to provide a translated virtual address based on said virtual address and a page table load response received from said page table.

2. The system as recited in claim 1 wherein said translatable virtual address is associated with a cache memory line of said buffer.

3. The system as recited in claim 1 wherein a virtual base address in said translatable virtual address identifies a version of said buffer.

4. The system as recited in claim 1 wherein said page directory processing circuit employs a two-level translation.

5. The system as recited in claim 1 further comprising a constant translation cache lookup circuit operable to employ a cache of recently translated addresses to determine if a translation request can be fulfilled from a cache.

6. The system as recited in claim 1 further comprising a translation miss buffer configured to contain miss request information.

7. The system as recited in claim 1 wherein said translated virtual address is a sum of a page directory entry employed as a base address and a field of said translatable virtual address employed as an offset.

8. A method of versioning states of a buffer, comprising:
storing a page table in a virtual address space;
providing a page table directory request for a translatable virtual address of said buffer to said page table; and
providing a translated virtual address based on said virtual address and a page table load response received from said page table.

9. The method as recited in claim 8 wherein said translatable virtual address is associated with a cache memory line of said buffer.

10. The method as recited in claim 8 wherein a virtual base address in said translatable virtual address identifies a version of said buffer.

11. The method as recited in claim 8 wherein said page directory processing circuit employs a two-level translation.

12. The method as recited in claim 8 further comprising employing a cache of recently translated addresses to determine if a translation request can be fulfilled from a cache.

13. The method as recited in claim 8 further comprising creating a translation miss buffer for containing miss request information.

14. The method as recited in claim 8 further comprising adding a page directory entry employed as a base address and a field of said translatable virtual address employed as an offset to form said translated virtual address.

15. A graphics processing unit, comprising:
a plurality of streaming multiprocessors;
a corresponding plurality of memories; and
a system for versioning states of a constant buffer storable in said plurality of memories, said system including:
a page table lookup and coalesce circuit operable to provide a page table directory request for a translatable virtual address of said constant buffer to a page table stored in a virtual address space, and
a page directory processing circuit associated with said page table lookup and coalesce circuit and operable to provide to one of said memories a translated virtual address based on said virtual address and a page table load response received from said page table.

16. The unit as recited in claim 15 wherein said translatable virtual address is associated with a cache memory line of said buffer.

17. The unit as recited in claim 15 wherein a virtual base address in said translatable virtual address identifies a version of said buffer.

18. The unit as recited in claim 15 wherein said system further includes a constant translation cache lookup circuit operable to employ a cache of recently translated addresses to determine if a translation request can be fulfilled from a cache.

19. The unit as recited in claim 15 wherein said system further includes a translation miss buffer configured to contain miss request information.

20. The unit as recited in claim 15 wherein said translated virtual address is a sum of a page directory entry employed as a base address and a field of said translatable virtual address employed as an offset.
